(19) United States
(12) Patent Application Publication
(10) Pub. No.: US 2007/0008688 A1
(43) Pub. Date: Jan. 11, 2007

(54) Briefcase with functions of accessing and playing multimedia files

(76) Inventor: Hsien-Rong Liang, Taipei City (TW)

Correspondence Address: Hsien-Rong LIANG, P. O. Box No. 6-57, Junghe, Taipei, 235, TW

(21) Appl. No.: 11/172,813

(22) Filed: Jul. 5, 2005

(51) Int. Cl. G06F 1/16

(52) U.S. Cl. 361/683

(57) ABSTRACT

A briefcase with functions of accessing and playing multimedia files is provided, wherein a circuit board is provided with transmission connectors and slots for connecting with digital information equipment and a memory card, as well as mutually transmitting digital files and multimedia files. A hard disk for storing digital files and multimedia files is also included in the briefcase. Moreover, a control and data processing for the aforementioned elements connected can be performed through control buttons, and the digital files and multimedia files inside the aforementioned memory card, digital information equipment, and hard disk can be played with speakers.

### BACKGROUND OF THE INVENTION

(a) Field of the Invention

The present invention relates to a briefcase with functions of accessing and playing multimedia files, and more particularly to a briefcase wherein a circuit board is located in a holding layer of a briefcase, and a plurality of perforations are located at side edge of the holding layer so as to insert a power circuit, connectors, a power connector, and slots of the circuit board. Moreover, external wraps are located at exteriors of the holding layer, so as to cover and wrap the holding layer to prevent dust or alien objects from entering, when the aforementioned device is not in use.

(b) Description of the Prior Art

A briefcase has become a necessary object for a working group in the circumstance of existing industrial and business society. The briefcase should always be carried for a business trip. However, the briefcase is generally used for saving documents and stationery. Therefore, if it is required to exchange digital files with clients, digital information equipment, such as a personal disk, should be prepared in advance, and the digital files can only be exchanged under a circumstance where a computer exists. In addition, as the digital information equipment has become a common product in daily life, if the digital information equipment can be used along with the briefcase, it will increase a working efficiency in doing business.

Accordingly, how to provide a briefcase which has functions of accessing and playing multimedia files, is a technical problem which needs to be solved by the inventor.

### SUMMARY OF THE INVENTION

The present invention is to provide a briefcase with functions of accessing and playing multimedia files, wherein a circuit board is located in a holding layer of a briefcase, and a plurality of perforations are located at side edge of the holding layer so as to insert a power circuit, connectors, a power connector, and slots of the circuit board. Moreover, external wraps are located at exteriors of the holding layer, so as to cover and wrap the holding layer to prevent dust or alien objects from entering, when the aforementioned device is not in use.

In addition, the holding layer is provided with chambers for holding digital information equipment (such as a personal digital assistant, a personal disk, a card reader, and a digital walkman), and the chambers are provided with connectors, and troughs for holding control buttons, so as to expose the control buttons, thereby facilitating operation.

The internal circuit board is provided with transmission connectors and slots for connecting with digital information equipment (such as a personal digital assistant, a personal disk, a card reader, and a digital walkman) and memory cards, so as to mutually transmit digital files and multimedia files. Moreover, the holding layer is also provided with a hard disk for storage of digital files and multimedia files, and the multimedia files can be played with speakers by a means of data processing control to the aforementioned elements through the control buttons.

In addition, a micro-processor inside the holding layer is used to process control signals, data transmission signals, and data computation between the aforementioned elements.

To enable a further understanding of the said objectives and the technological methods of the invention herein, the brief description of the drawings below is followed by the detailed description of the preferred embodiments.

### BRIEF DESCRIPTION OF THE DRAWINGS

FIG. 1 shows a perspective view of the present invention.

FIG. 2 shows a perspective view of compartments of the present invention.

FIG. 3 shows a circuit block diagram of the present invention.

FIG. 4 shows a schematic view of an implementation of the present invention.

### DETAILED DESCRIPTION OF THE PREFERRED EMBODIMENTS

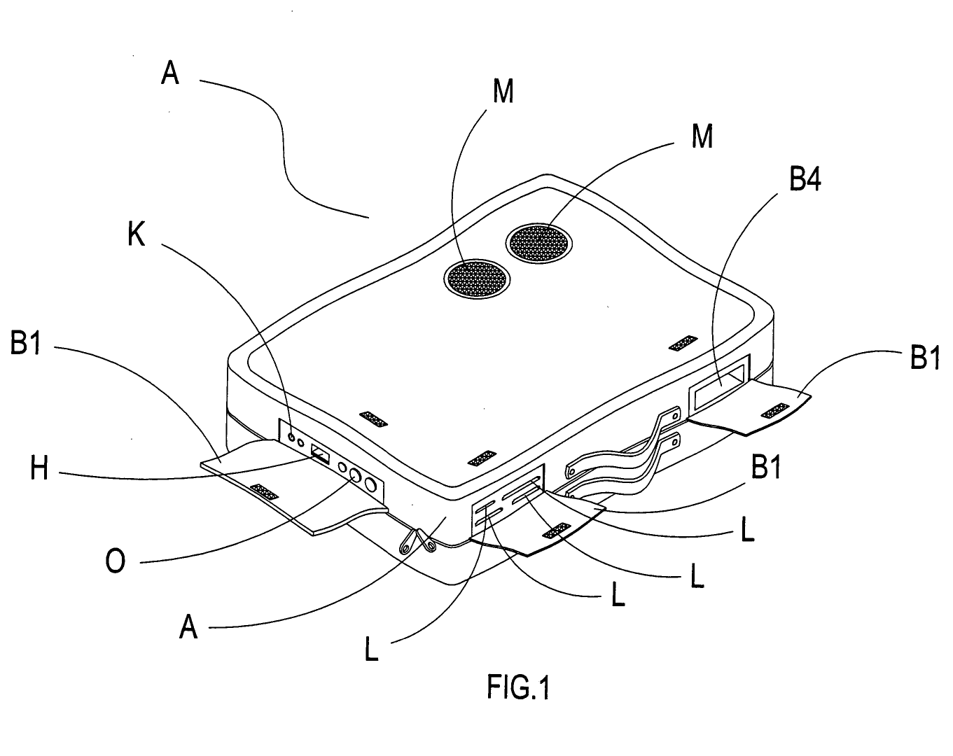

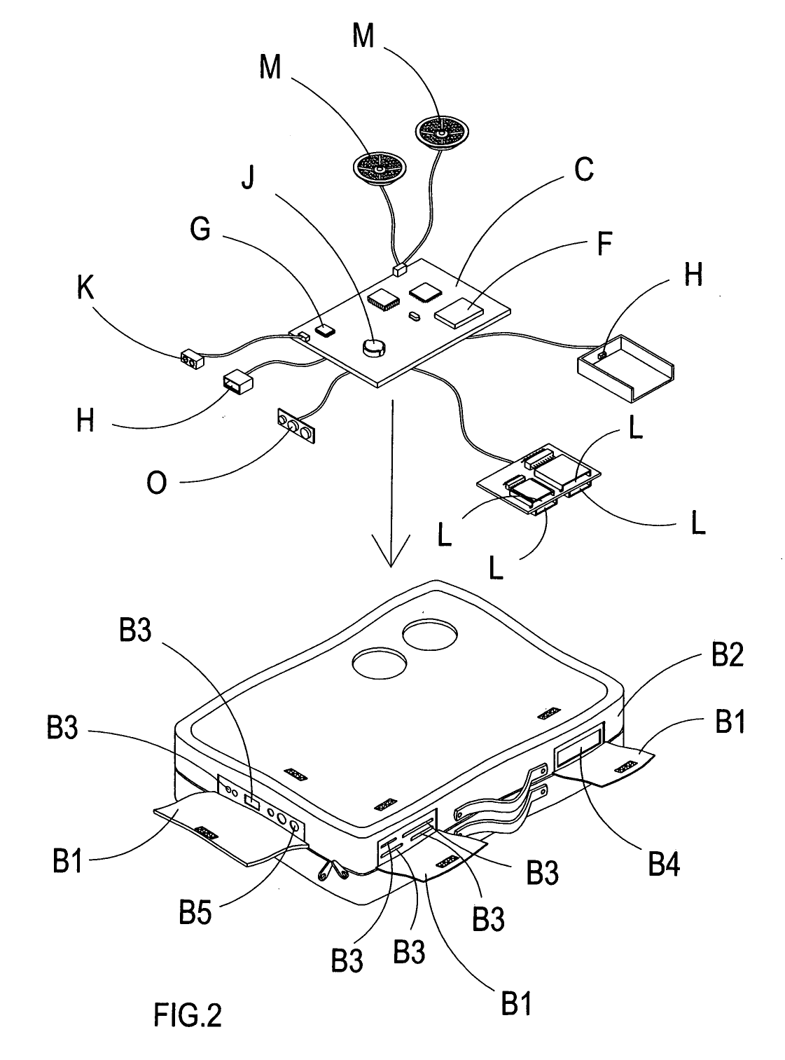

Referring to FIG. 1 and FIG. 2, a circuit board C is located in a holding layer B inside a briefcase A. The holding layer B is provided with external wraps B1, side edge B2, perforations B3, chambers B4, and troughs B5.

The circuit board C is provided with a micro-processor D, a transmission control circuit E, a hard disk F, a power circuit G, connectors H, an audio line connector I, a battery J, a power connector K, slots L, speakers M, and control buttons O. The feature of structure lies in that the circuit board C is emplaced in the holding layer B of the briefcase A, and a plurality of perforations B3 are located at the side edge B2 of the holding layer B, so as to insert the power circuit G, the connectors H, the power connector K, and the slots L of the circuit board C. Moreover, the external wraps B1 are located at exteriors of the holding layer B, so as to cover and wrap the holding layer B to prevent dust or alien objects from entering, when the aforementioned device is not in use.

In addition, the holding layer B is provided with the chambers B4 for holding digital information equipment (such as a personal digital assistant, a personal disk, a card reader, and a digital walkman), and the chambers B4 are provided with connectors H, and troughs B5 for holding control buttons O, so as to expose the control buttons, thereby facilitating operation.

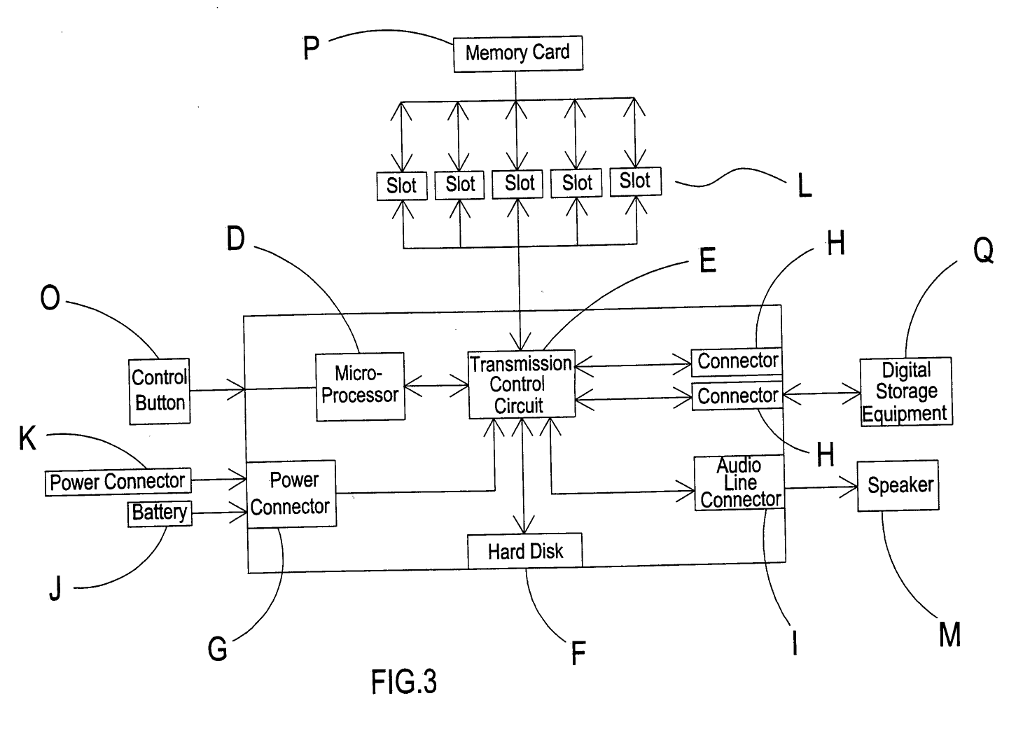

Referring to FIG. 3, functions of elements of the circuit board are as follows:

The plurality of slots L corresponding to memory cards P of various specifications are connected with the memory cards P of corresponding specifications respectively, and are used to perform access and transmission to digital files and multimedia files inside the aforementioned memory cards P.

The connectors H are located at the perforations B3 and chambers B4 of the holding layer B, and are directly connected with digital information equipment Q (such as a personal digital assistant, a personal disk, and a card reader), and perform access and transmission to the digital files and multimedia files inside the digital information equipment Q.

The hard disk F is used as storage for the digital files and multimedia files.

The speakers G are connected with the audio line connector I of the circuit board C, and are used to play the multimedia files inside the aforementioned memory card P, digital information equipment Q, and hard disk F.

The transmission control circuit E is connected with the aforementioned hard disk F, connectors H, audio line connector I, and slots L, as well as performs access and transmission to the digital files and multimedia files between the connected memory card P, digital information equipment H, and hard disk F.

The micro-processor D is used to process control signals, data transmission signals, and data computation between the aforementioned elements inside the circuit board C, and is connected with the aforementioned transmission control circuit E.

The control buttons O are used to transmit press-button control signals to the micro-processor D, so as to enable the aforementioned micro-processor D to perform operation to the corresponding control signals.

The power connector K is connected with a main power supply through a power cord, so as to enable an external power to transmit to an interior of the power circuit G, and enable an AC (alternating current) or DC (direct current) power to be converted to a DC power, for providing a working power to the aforementioned circuit board C. Moreover, the circuit board C is provided with the battery J, such that the aforementioned circuit C can operate normally when there is no external power, and can charge to the battery J and the aforementioned digital information equipment Q.

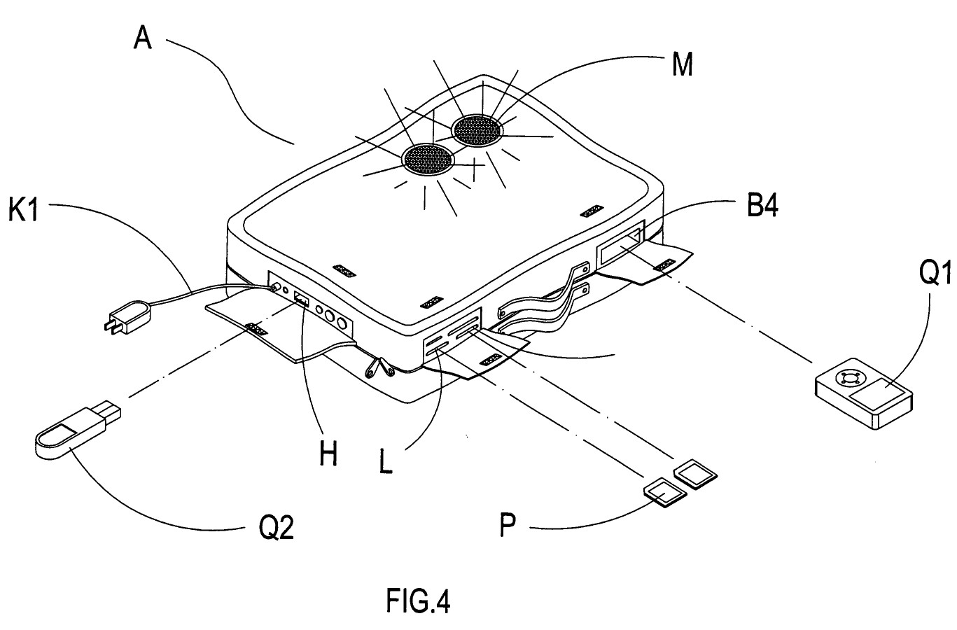

Referring to FIG. 4 (along with FIG. 3), it shows an implementation of the present invention. The briefcase A is connected with the memory card P, a digital walkman Q1, or a personal disk Q2, wherein the memory card P is inserted into the slot L of the corresponding specification, the digital walkman Q1 is first located in the holding layer B4, then connected with the connector H, and the personal disk Q2 is connected with the connector H.

The control signals are generated by the control buttons O and transmitted to the micro-processor D, which controls the transmission control circuit E, so as to perform transmission and access to the digital files and multimedia files between the connected memory card P, digital walkman Q1, or personal disk Q2 and the interior hard disk F.

In addition, the multimedia files inside the aforementioned memory card P, digital walkman Q1, personal disk Q2, or hard disk F are played through the speakers M.

Under the aforementioned connection status, the power cord K1 is connected with the main power supply (such as an outlet) to convert an AC or DC power to a working power of all elements on the circuit board C through the power circuit G, and to charge to the battery J and digital walkman Q1.

To further manifest the advancement and practicability of the present invention, the present invention is compared with a conventional application as follow:

Shortcomings of a conventional application
(1) A briefcase can be only used to carry documents and stationery.
(2) Using digital information equipment to covert files must be performed in a circumstance where a computer exists.
(3) It cannot be used to increase a working efficiency.

### ADVANTAGES OF THE PRESENT INVENTION

(1) It can be compatible with memory cards of many different specifications.
(2) It can be connected with digital information equipment (such as a digital walkman, or a personal disk).
(3) It can be used to transmit data between digital information equipment and a memory card.
(4) According to items 1, 2, and 3, it can play multimedia files inside the briefcase.
(5) According to items 1, 2, and 3, it can save digital files into an internal hard disk, and is provided with a function of personal disk.
(6) It has an advancement, practicability, and amusement.
(7) It can promote an industrial competitiveness.

It is of course to be understood that the embodiments described herein is merely illustrative of the principles of the invention and that a wide variety of modifications thereto may be effected by persons skilled in the art without departing from the spirit and scope of the invention as set forth in the following claims.

What is claimed is:

1. A briefcase with functions of accessing and playing multimedia files, comprising a circuit board is installed in a holding layer inside the briefcase, and the circuit board is provided with a micro-processor, a transmission control circuit, a hard disk, a power circuit, connectors, an audio line connector, a battery, a power connector, slots, speakers, and control buttons; the plurality of slots being installed corresponding to different specifications of memory cards connected with the memory cards of corresponding specifications, and digital files and multimedia files inside the aforementioned memory cards accessed and played; the connectors being installed on perforations of the holding layer and chambers, being directly connected with digital information equipment, and being used to perform access and transmission to the digital files and multimedia files inside the digital information equipment; the hard disk being used for a storage of digital files and multimedia files; the speakers being connected with the audio line connector on the circuit board and being used to play the multimedia files inside the aforementioned memory card, digital information equipment, and hard disk; the transmission control circuit being connected with the aforementioned hard disk, connectors, audio line connector, and slots, and being used to perform access and transmission to the digital files and multimedia files between the connected memory card, digital information equipment, and hard disk; the micro-processor being used for processing control signals, data transmission signals, and data computation between the aforementioned elements inside the circuit board; the control buttons being used to transmit the press-button control signals to the micro-processor, so as to enable the aforementioned micro-processor to perform operation to the corresponding control signals; the power connector being connected with a main power supply through a power cord, so as to transmit an external power to the power circuit, and to convert an AC or DC power to a DC power for providing a working power to the aforementioned circuit board; the circuit board is provided with a battery, such that the aforementioned circuit board can operate normally when there is no external power; the aforementioned circuit board being used to charge to the battery and the aforementioned digital information equipment.

2. The briefcase with functions of accessing and playing multimedia files according to claim 1, comprising the holding layer of briefcase is provided with side edge, perforations, chambers, troughs, and a circuit board; the feature of structure including emplacing the circuit board in the holding layer of the briefcase, and installing the plurality of perforations at side edge of the holding layer, so as to insert the power circuit, connectors, power connector, and slots of the circuit board.

3. The briefcase with functions of accessing and playing multimedia files according to claim 1, comprising the slots are corresponding to memory cards of different specifications, such as a CF card (Compact Flash Memory Card), a Type-I CF card, a Type-II CF Card, an MS card (Memory Stick Memory Card), an MGMS card (Magic Gate Memory Stick Memory Card), a Duo-MS card (Duo Memory Stick Memory Card), a Pro-MS card (Pro Memory Stick Memory Card), an MMC card (Multi-Media Memory Card), an MMC 4.0 card (Multi-Media Memory Card Ver 4.0), a RSMMC card (Reduced Size Multi-Media Memory Card), an SD card (Secure Digital Memory Card), a Mini SD card, an SM card (Smart Media Memory Card), an Xd card (extreme Digital Picture Memory Card), and digital information storage media with related specification.

4. The briefcase with functions of accessing and playing multimedia files according to claim 1, comprising the connectors are further to be an USB port (Universal Serial Bus), an IEEE 1394 (Institute of Electrical and Electronic Engineers Standard Bus Interface) and SATA (Serial Advanced Technology Attachment) port, and a related connection and transmission port for digital information.

5. The briefcase with functions of accessing and playing multimedia files according to claim 1, comprising the transmission circuit is further an USB-OTG (Universal Serial Bus-ON-TO-GO) and a related integrated circuit of transmission interface.
